(19) United States
(12) Patent Application Publication
(10) Pub. No.: US 2015/0302506 A1
(43) Pub. Date: Oct. 22, 2015

(54) Method for Securing an Order or Purchase Operation Means of a Client Device

(71) Applicants: Giampaolo FRANCHI, ROME (IT); Emiliano VERNINI, FROSINONE (IT); Massimiliano CIRILLO, GROTTAFERRATA (IT)

(72) Inventors: Giampaolo FRANCHI, ROME (IT); Emiliano VERNINI, FROSINONE (IT); Massimiliano CIRILLO, GROTTAFERRATA (IT)

(73) Assignee: POSTECOM S.P.A., ROME (IT)

(21) Appl. No.: 14/418,619

(22) PCT Filed: Aug. 1, 2012
(86) PCT No.: PCT/IT2012/000241

§ 371 Date: May 5, 2015

(51) Int. Cl. G06Q 30/06

(52) U.S. Cl. CPC G06Q 30/0633; G06Q 2220/00

(57) ABSTRACT

A method (100) for securing an order or purchase Operation—by means of a client device (201) is described, comprising the steps of:—installing (101) an application programme on the client device (201) adapted for placing the client device (201) in communication with a server device (205) by means of a telecommunications network the application programme permitting a user to enter data useful for the purposes of performing the order or purchase operation and of transmitting said useful data to the server device (205);—running (102) the application programme on the client device (201) to perform said order or purchase operation;—installing (103) once and for all a digital certificate directly on the client device (201);—entering (105) said data useful for the performance of the order or purchase operation; The method (10) further comprises a step of authorising (106) the order or purchase operation by means of the client device (201) sending an encrypted message containing said useful data from the client device (201) to the server device (205), using the digital certificate installed as a private key to obtain the encrypted message, said private key being specific for said order or purchase operation.

The present description refers to the technical sector of securing internet communications between a client device and a server device and relates in particular to a method for securing an order or purchase operation by means of a client device.

Systems and methods are known which enable a user to secure an order or purchase operation to be performed on internet by means of a client device.

The aforesaid systems and methods generally envisage that the user avails of a personal and dedicated OTP generator (one time password) so as to generate a password which the user enters into the client device, such as a PC, for the encryption of the data to be sent to the server device to secure the order or purchase operation. The password generator device may also be provided with a chip reader, (called Personal Card Reader) and programmed to generate a password after reading the chip at the user's request, generally after he/she has entered a PIN associated with the chip. Alternatively the aforementioned password generator may be an independent generator suitable for generating continuously over time a sequence of passwords at predefined time intervals.

By the fact of entailing a dedicated device for generating passwords the securing methods of the prior art, despite being widely used, show room for improvement as regards convenience and user experience. The securing procedure is in fact complex in that, apart from the inconvenience of having to carry around the dedicated device at all times, it, requires transcribing of the password generated by the dedicated device on the client device and such transcription may be subject to error following which, annoyingly, the entire procedure has to be repeated. The aforementioned drawbacks would moreover render the procedure particularly inconvenient were the client device a personal mobile communication device, such as for example a smartphone, a PDA, netbook or a PC tablet. Last but not least, the dedicated password generation device could be subject to breakage, malfunction, damage or could be subject to its power supply batteries going flat.

The need is therefore felt to make available a method for the securing of a transaction or purchase operation which does not have the drawbacks of the methods of the prior art.

The objective of the present description is to make available a securing method making it possible to satisfy the aforementoned need.

The aforementioned objective is achieved by a securing method as defined in general in the appended first claim in its more general form and in the dependent claims in some of its particular embodiments.

The invention will be understood more clearly from the detailed description which follows made by way of a non-limiting example in relation to the appended drawings, wherein:

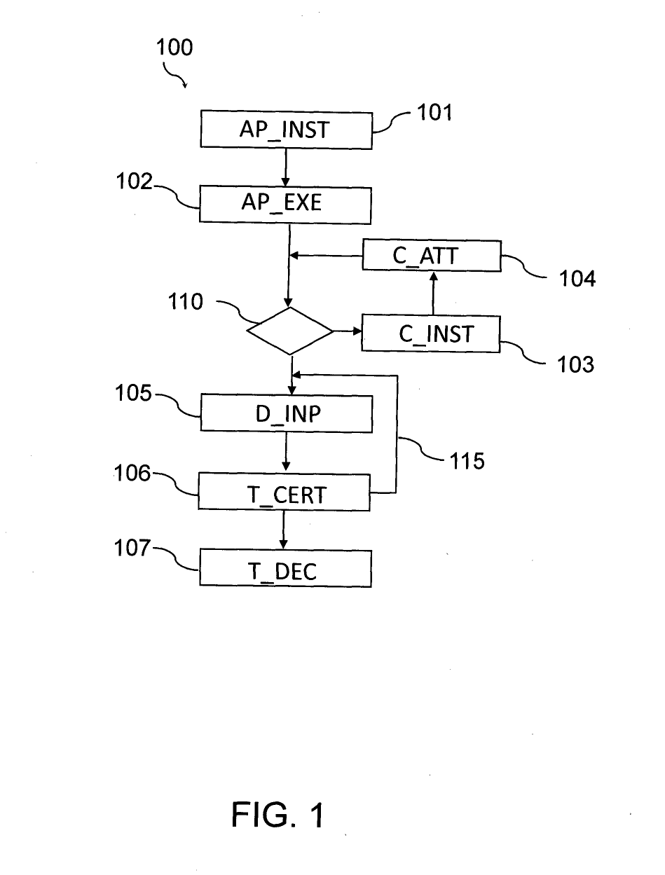

FIG. 1 shows a flow chart of an example of an example of a method for securitising an order or purchase operation;

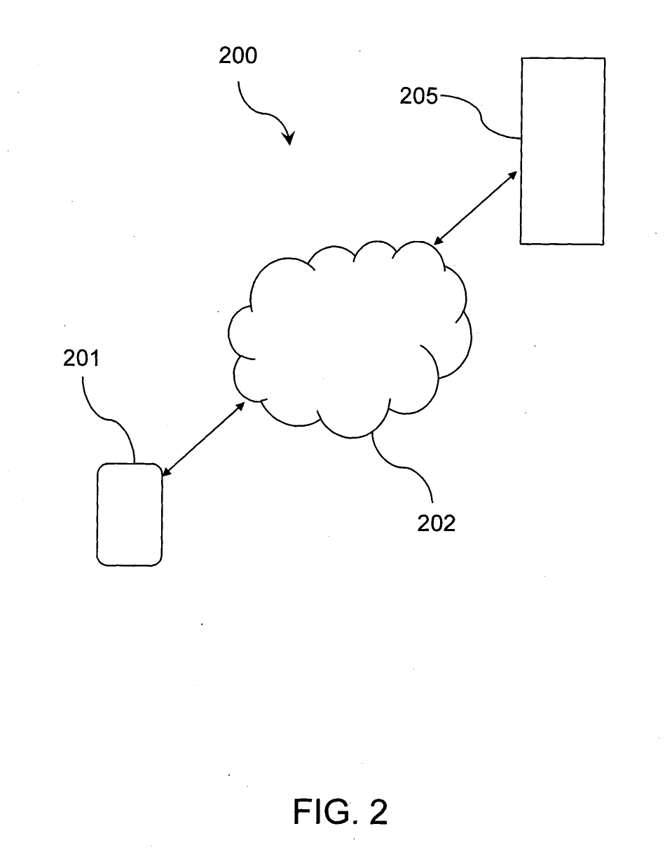

FIG. 2 shows, by way of a non-limiting example, a functional block diagram of a telecommunications system adapted for actuating the securing method in FIG. 1, the system comprising at least one server device and at least one client device.

In the figures, elements which are the same or similar have been indicated using the same reference numerals.

With reference to FIG. 1, reference numeral 100 globally denotes the flow chart of a method for securing an order or purchase operation.

FIG. 2 shows, by way of a non-limiting example, a functional block diagram of a telecommunications system 200 by means of which the method 100 in FIG. 1 may be actuated. In FIG. 2 reference numeral 201 globally denotes a client device that is to say a telecommunications terminal by means of which a user may perform the order or purchase operation. Reference numeral 205 globally denotes the server device, that is to say the entity or set of hardware/software components destined to receive the requests of various client devices associated with respective users to permit the same to perform their order or purchase operations. In addition the aforesaid server 205 may also be configured to enable the client devices 201 to avail of information type functions.

According to embodiment, the client device 201 is a personal mobile communication device, for example provided with a graphic display interface, preferably a touch screen. According to a more specific embodiment, the client device 201 is a smart-phone or a PC tablet provided with an internet interface. In one possible alternative embodiment, the aforesaid client device 201 is for example a smart-TV or a set top box.

The server device 205 is a hardware/software system which may take the physical form, regardless, of a single processor which various software modules run on and having a database or a set of distributed processors and databases interconnected to each other, each responsible for performing one or more specific functions.

With reference to FIG. 1, the various steps of the securing method 100 will be described hereafter.

According to one possible non-limiting embodiment, the aforesaid securing method 100 is a method implemented to perform on-line banking transactions from a mobile client device 201. One possible type of transaction is for example a credit transfer, a payment, a top-up operation from a current account of a prepaid card. For the sake of simplicity, and without by so doing introducing any limitation, reference will be made hereinafter in this description to the case in which the client device 201 is a smartphone.

The method 100 comprises a step of installing 101 (AP INST) an application programme on the client device 201 thus, in the example, on the smart-phone, that is to say in this specific example an APP, suitable for placing the smartphone 201 in communication with a remote server device 205 by means of a telecommunications network 202. Such application programme permits a user to enter data into the client device 201 useful for the purposes of performing the order or purchase operation and transmitting useful data to the server device 205. According to embodiment, the aforesaid APP is an on-line banking programme which permits the user both to manage his/her current account and to display information relative to such current account via the smartphone 201, having therefore both order and information functions. In an alternative embodiment the aforesaid APP is a specific APP, for example envisaged for topping up a prepaid debit card from a current account or envisaged for paying a postal payment slip from a current account or envisaged for topping up a prepaid phone card. In a further embodiment, wherein the client device 201 is a smart-TV or a top-box set, the aforementioned APP is a specific programme which enables a user to purchase viewing of a TV programme, film or sports event on-demand.

The securing method 100 further comprises a step of running 102 (AP EXE) the application programme on the client device 201, that is on the smartphone in this example, to perform said order or purchase operation. According to embodiment, the step of running 102 the application programme comprises a preliminary operation of authentication of the user by means of credentials. For example, said credentials are the same credentials used for the authentication of the user by a programme with a web interface for the home banking type management of the current account.

It is clear that the client device 201 is a device comprising a processor, a memory and portions of code which can be directly loaded in the memory and run by the processor to enable said client device 201 to run the aforesaid application programme.

The securing step 100 comprises a step of installing 103 (C INST), once and for all, a digital certificate directly on the client device 201, in the example, on the smartphone 201. According to one embodiment the aforesaid digital certificate is adapted for making the client device 201 equivalent in terms of security to a hardware token. One example of a possible digital certificate which can be installed called “ArcotID™ proves particularly solid and is based on a technology called “Cryptographic Camouflage”.

A digital certificate of the type described above is based on a PKI infrastructure (Public Key Infrastructure) in other words on the encryption of the messages exchanged between the client device 201 and server device 205 by means of a pair of so-called asymmetric keys, wherein the private key is held by the user and used to encrypt the communications sent from the client device to the server device.

Public key encryption is a coding method in which two mathematically correlated “keys” (apparently random strings of numbers) are used to encrypt and decrypt the messages and data exchanged between the holders of the aforesaid keys. The messages encrypted with one key can only be decrypted with the correlated key and vice versa.

If one of the keys is kept secret by the holder and the other, related to the identity of the holder, is rendered public, one has a public key infrastructure.

In the above scenario, the set of public keys is held by the server device 205, and the private key may be used to encrypt a message or request sent from the client device of a user, which can be decrypted exclusively using the correlated public key held by the server device 205.

In the embodiment described above the digital certificate installed through step 103 is protected with the private key and connected in a univocal way to the client device 201 which it is installed on. As will be described henceforth, the aforesaid private key is used to generate a response signing a challenge sent by the server during the authorisation step of the transaction.

The correct decrypting of the private key by means of the corresponding public key held by the server device 205 is the factor which enables the user to conclude the transaction.

The scenario described above clearly shows how the reliability of the PKI infrastructure lies in its ability to defend the secrecy of the private key held by the user. The private key can be stored in an encrypted software module, however it remains subject to “brute force” offline attacks wherein an attacker attempts to find the key by trying all possible passwords. In the more common encryption methods of the private key the risk is quite high, especially if users. use words that are easy to remember as passwords. Thanks to its specific features, the technology known as “Cryptographic Camouflage” makes it possible to protect the digital certificate from the aforementioned “brute force” type attacks by making the encryption method particularly solid.

According to one embodiment the installation step 103 of the securing method 100 comprises an operation to perform a download of the digital certificate from remote and the application programme is configured so that said download may be started directly by the application programme.

For example, as shown by the conditional block 110 in FIG. 2 the application programme is able to verify whether said digital certificate is installed and activated on said client device 201 and to propose and start the installation step 103 and the download of the certificate if such verification should show that said certificate has not been installed and activated. Otherwise the subsequent step 105 (D INP) described below may be performed.

According to embodiment, the securing method 100 comprises a step of activating 104 the digital certificate, comprising an operation of sending an activation code to the user at an address previously certified de visu. For example the certified address de visu is a telephone number and the activation code is sent by means of a text message to said user.

In one embodiment, it may be envisaged that once the activation step has been launched by the application programme the client is shown a message by the client device 201 requesting that he/she phone a free-phone number. Following such call, which for example may be handled remotely by an automated system, the user receives an activation code. At this point the user may enter said code in the client device 201 so as to complete activation of the digital certificate. For example, according to one embodiment the activation step 104, after insertion of the correct activation code, comprises a step of selecting and entering a PIN by the user to be used to secure the order or purchase operation, that is to perform the authorising step 106 which will be described henceforth.

According to one particularly advantageous embodiment as far as security is concerned, in the activating step 104 the client device 201 is such as to send the server device 205 an activation request comprising at least one univocal identification parameter of the client device 201, such as for example the MAC address of the wireless interface of the client device 201 or the serial number of the client device 201.

This way it is possible to verify that after entering the activation code, the activation code is entered in the same client device which made the activation request, for example to prevent attempts at fraud by the ill-intentioned through sniffing of the activation code, for example in the case in which such is sent to the user by SMS.

After successfully completing the installation 103 and activations 104 steps, the method 100 comprises a step by means of which the user can enter data into the client device 201 by means of the application programme useful for the purposes of performing the order or purchase operation. For example, in the case in which the order operation is a credit transfer, such data includes identification data of the recipient current account, reason for payment and amount to be credited. In another example, in the case in which the order operation is topping up a debit card, such data includes an identification number of the debit card and the amount to be topped up.

After completing the step of entering the data, the method 100 comprises a step of authorising 106 the order or purchase operation by means of the client device 201 sending an encrypted message containing said useful data from the client device 201 to the server device 205, using the software certificate installed as a private key to obtain the encrypted message. Such private key is a specific encryption key for said order or purchase operation.

According to one advantageous embodiment the aforesaid authorisation step 106 is preceded and conditioned by an operation of entering the PIN in the client device 201. For example, such entering of the PIN is preceded by a challenge sent by the server device 205 to the client device 201 and the PIN is suitable for unblocking the digital certificate for the production of a response in a so-called challenge-response type mechanism. Such response makes it possible to obtain the encrypted message sent from the client device to the server device.

Lastly, as shown in FIG. 1, the method comprises the step of decrypting 107 (T DEC) the aforesaid message in the server device 205 by means of a public key held by the server device 205.

As shown by the arrow 115 in FIG. 1 after the authorisation step the user may, at his/her discretion and as required, repeat the steps 105 and 106 to perform further order or purchase operations.

Again with reference to FIG. 1 one may observe that after the once and for all installation of the application programme (step 101), of the digital certificate (step 103) and after activation of the digital certificate (step 104), the client device 201 is certified and the method is simplified to steps 102, 105,106 and 107 every time the user needs to perform order or purchase operations.

As is clear from the above description, the objectives stated may be fully achieved by a method of the type described above. From the description above it is in fact clear how the securing of the order and purchase operations is particularly simple and practical as regards user experience, but at the same time solid and secure as regards possible fraud attacks by the ill-intentioned.

Obviously, a person skilled in the art may make numerous modifications and variations to the securing method described above so as to satisfy contingent and specific requirements, while remaining within the sphere of protection of the invention, as defined by the following claims.

1. Method for securing an order or purchase operation by means of a client device, comprising the steps of:
installing an application programme on the client device adapted for placing the client device in communication with a server device by means of a telecommunications network, the application programme permitting a user to enter data useful for the purposes of performing the order or purchase operation and of transmitting said useful data to the server device;
running the application programme on the client device to perform said order or purchase operation;
installing once and for all a digital certificate directly on the client device;
entering said data useful for the performance of the order or purchase operation;
authorising the order or purchase operation by means of the client device sending an encrypted message containing said useful data from the client device to the server device, using the digital certificate installed on the client deice as a private encryption key to obtain the encrypted message, said private key being specific for said order or purchase operation.

2. Method according to claim 1, wherein the digital certificate is suitable for making the client device equivalent in terms of security to a hardware token.

3. Method according to claim 1, wherein the client device is a personal mobile communication device.

4. Method according to claim 1, wherein the aforesaid authorisation step is preceded and conditioned by an operation of entering a PIN in the client device.

5. Method according to claim 1, comprising a step of decrypting said encrypted message at the server device by means of a public key held by said server device.

6. Method according to claim 1, comprising an operation to perform a remote download of said digital certificate and wherein the application programme is configured so that said download may be started directly by said application programme.

7. Method according to claim 6, wherein said application programme is adapted to verify whether said digital certificate is installed or not on said client device and to propose and start the download if said verification shows that said certificate is not installed.

8. Method according to claim 7, comprising a step of activating said digital certificate comprising an operation of sending an activation code to the user at an address certified de visu.

9. Method according to claim 8, wherein said certified address de visu is a telephone number and wherein said activation code is sent by means of a text message to said user.

10. Method according to claim 7, wherein the activating step comprises a step of selecting and entering a PIN by the user to be used to perform the authorising step.

11. Method according to claim 8, wherein in the activating step the client device is such as to send the server device an activation request comprising at least one univocal identification parameter of said client device.

12. Method according to claim 1, wherein said step of running the application programme comprises a preliminary operation of authentication of the user by mean of credentials.

13. Application programme comprising code instructions executable by the client device to interface with the server device so as to carry out a method according to claim 1.

14. Client device comprising a processor, a memory and code portions which can be directly loaded in the memory and run by the processor to enable the client device to run an application programme according to claim 13.

15. Client device according to claim 14, wherein said device is a smart-phone, a PC tablet or a smart TV.

16. Server device suitable for interfacing with the client device by means of said application programme to perform a method according to claim 1.
